(19) United States
(12) Patent Application Publication
(10) Pub. No.: US 2019/0325448 A1
(43) Pub. Date: Oct. 24, 2019

(54) SOCIAL MEDIA BASED BILL PAY AND AUTHENTICATION

(71) Applicant: Wells Fargo Bank, N.A., San Francisco, CA (US)

(72) Inventors: Wayne Barakat, Novato, CA (US); Ross M. Cavanaugh, Harrisburg, NC (US); Nathan B. Coles, El Cerrito, CA (US); Randy E. Furr, Charlotte, NC (US)

(21) Appl. No.: 14/984,374

(22) Filed: Dec. 30, 2015

(51) Int. Cl. G06Q 20/40; G06Q 50/00; G06Q 20/10

(52) U.S. Cl. CPC G06Q 20/4016; G06Q 20/102; G06Q 20/407; G06Q 50/01

(57) ABSTRACT

A method for performing payment transactions via social media includes obtaining social user messages generated by a user on a social media system; identifying a payment command within the social user messages based on contextual cues within the social user messages; and initiating a funds payment transaction based on the payment command. Other systems, apparatuses, and methods are also described.

### TECHNICAL FIELD

Embodiments pertain to social media payments. Some embodiments relate to examining information within social media posts to determine transaction parameters.

### BACKGROUND

Banking account holders often wish to make payments to non-merchant parties. For example, in social situations, it is often desirable to split a restaurant tab or contribute to other funds or expenses. Systems and methods for facilitating such payments should be flexible and easy to use to fit into account holders' active lifestyles.

### BRIEF DESCRIPTION OF THE DRAWINGS

In the drawings, which are not necessarily drawn to scale, like numerals can describe similar components in different views. Like numerals having different letter suffixes can represent different instances of similar components. Some embodiments are illustrated by way of example, and not of limitation, in the figures of the accompanying drawings, in which:

FIG. 1 illustrates a block diagram of a system in which any one or more of the techniques (e.g., methodologies) discussed herein can be performed, according to an example embodiment;

FIG. 2 is a block diagram of a social payment system, according to an example embodiment;

FIG. 3 shows a flowchart of a method of generating a social media payment, according to an example embodiment; and

FIG. 4 is a block diagram illustrating an example machine upon which any one or more of the techniques (e.g., methodologies) discussed herein can be performed, according to an example embodiment.

### DETAILED DESCRIPTION

Banking customers today lead active lifestyles and appreciate flexibility in the methods in which they can provide payments. For example, banking customers who use social media applications appreciate the opportunity to make payments to merchants, financial institutions, utilities, etc., via these social media applications. As another example, when in a social situation, it can be convenient to the banking customer to provide payment to a friend or other social contact via a social media application.

Methods and systems in accordance with various embodiments provide for a bank customer to register his social media accounts with his financial institution by enrolling his bank accounts in a social payment system, thereby enabling the financial institution to view the posts/messages of the customer. The customer can then initiate payments to companies or other individuals by sending the recipient a message, posting a message on the recipient's profile (e.g., wall post), or mentioning the recipient in a social media post. As further described herein, in accordance with various embodiments, the financial institution can monitor social media for payment messages and initiate payments accordingly. The financial institution can take into account various contextual cues from the posts themselves, or from user account information, user location information, friends lists, etc., when parsing payment messages and when initiating payments.

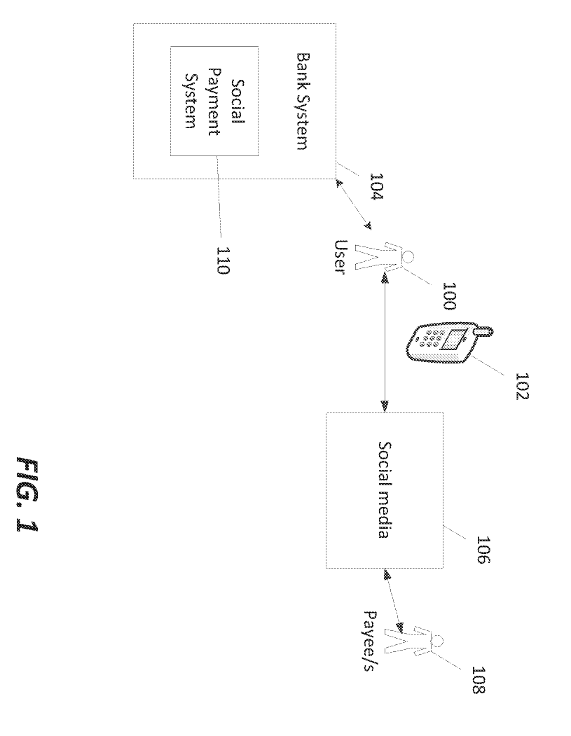

FIG. 1 illustrates a block diagram of a system in which any one or more of the techniques (e.g., methodologies) discussed herein can be performed, according to an example embodiment. As illustrated in FIG. 1, a user 100 uses a customer system 102 to perform financial transactions. The customer system 102 can include a desktop computer, mobile device, automated teller machine (ATM), wearable device, etc. Mobile devices can include various wireless devices that can communicate with the bank system 104. For example, mobile devices can include cellular telephones, smart phones, handheld personal communication devices, laptops, tablet computers, etc.

Embodiments leverage one or more social media networks 106 such that the social media network 106 can act as an agent between the user 100 and one or more payee/s 108. In embodiments, the user 100 uses the customer system 102 to provide the bank system 104 with access to posts that the user 100 makes on a social media network 106. The user 100 verifies and affirms that the given social media accounts belong to the user 100 and the user 100 can link various multiple social media accounts, using the customer system 102 to user 100 accounts on the bank system 104 using an enrollment process described later herein. The bank system 104 validates and ensures that the accounts are real and actually belong to the user 100, using any of the methodologies described later herein.

The bank system 104 can be owned and maintained at one or more financial institutions (e.g., banks, credit unions, savings and loan associations, and other institutions maintaining accounts) to access accounts held at the respective financial institution/s. Similarly, a payee 108 can receive payment from the bank system 104. The customer system 102 can display a representation of the status of a financial transaction during one or more phases of the financial transaction, in real time or near real time.

In some embodiments, the social payment system 110 can generate a social payment enrollment request and provide the social payment enrollment request to the bank system 104. The request can be include in, e.g., a secure hypertext transfer protocol message (HTTPS) by way of example. In some embodiments, the social payment system 110 can provide a social network login request to the customer system 102. The request can include, for example, an HTML input form in which the user 100 can enter social media login information (e.g., a Facebook user name and password). In some embodiments, the social payment system 110 will not store this social media login information.

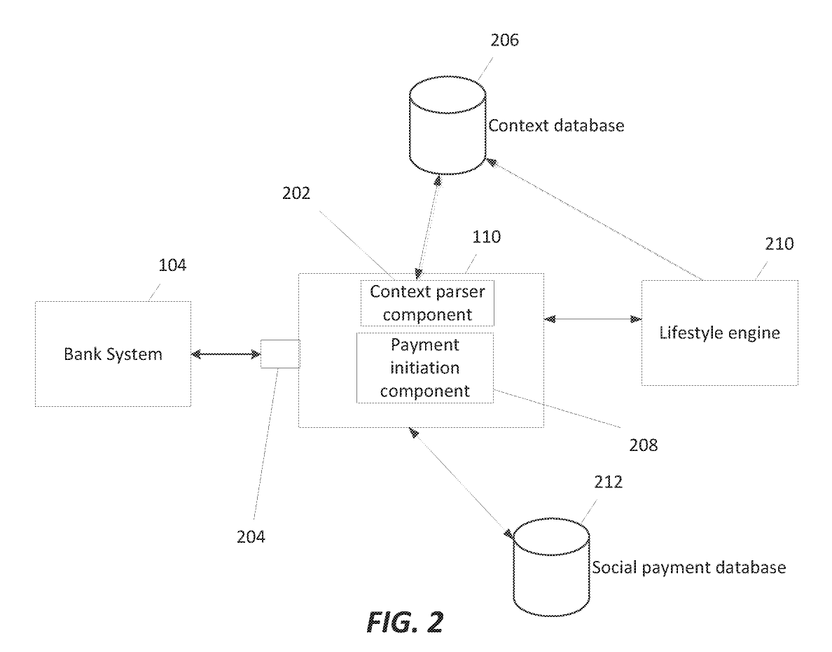

In some embodiments, the social media network 106 can authenticate the login credentials of the user 100, and upon doing so, update the social profile of the user 100 to indicate the user 100 enrollment in the social payment system. This enrollment can indicate to the social media network 106 that the social media network 106 has permission to provide user 100 social information to the bank system 104 and/or to the social payment system 110. For example, the enrollment can indicate that the bank system 104 or the social payment 110 is permitted access to user 100 social media posts, texts, messages, history, photographs, location-based information, etc. Upon receiving notification of enrollment from the social media network 106 or the social payment system 110 can generate an enrollment data record and store the enrollment data record in a social payment database 212 (FIG. 2). In some embodiments, the enrollment data record can store information regarding recent payments, payees, contexts in which payments were made, etc. The user 100 can terminate access to social media posts, texts, messages, etc. at any time.

Some embodiments facilitate person-to-person (P2P) payments, for example in social situations such as cab-fare sharing, restaurant tab splitting, gift pools, etc. These and other embodiments can also facilitate payments to a merchant, utility, or other business (P2B). The user 100 uses his account on the social media network 106 to initiate payments to payees 108 who are also registered on the social media network 106 or in another similar, linked social media network 106. In embodiments, these payees 108 are also enrolled with the same or other financial institution to receive payments according to methodologies described herein. In embodiments, the payees 108 may not hold an account into which the user 100 can pay funds, or may not have an account enrolled, in which case systems and methods in accordance with various embodiments can prompt the payee 108 to provide account information.

In some embodiments, the user 100 can use the customer system 102 to post a message on a social media network 106. In some embodiments, the social message includes posts, tweets, texts, etc., and can include information on the amount of funds to be transferred and an identity of another user to whom the funds should be transferred. In some embodiments, the bank system 104 can access the social media accounts. In some embodiments, the bank system 104 will intercept social media network 106 posts before or at the same time as the social media network 106 posts are received by the social media network 106, whereas in other embodiments, the social media network 106 will provide the message to the bank system 104. The bank system 104 can use the social post message to resolve identities of at least the user 100 and the payee/s 108. The bank system 104 can identify accounts of the user 100 and accounts associated with the payee 108, and the amount to be transferred between accounts. Using this information (e.g., account numbers, amounts, etc.), the bank system 104 can perform the transfer, provide fraud alerts, or take any other action described herein.

By way of illustrative example, the user 100 can make a Facebook™ post with a nonce or keyword or hashtag (e.g., #pay JoeW1234 500.00) to transfer $500.00 to a payee 108 (with user ID JoeW1234). The user 100 can request or be provided with various acknowledgments or confirmations, e.g., the user 100 can receive an acknowledgement that the payee 108 (user ID JoeW1234) received the funds, or that the transfer has been accepted by the bank system 104, by way of example. In some embodiments, a payee 108 can request a fund transfer through social media from the user 100. In at least these embodiments, the bank system 104 can notify the user 100 of the request and perform the transfer upon the user 100 confirming the transfer. The notification and confirmation can occur through social media or through another interface (e.g., a banking interface displayed on the customer system 102).

Methods and systems in accordance with some embodiments can allow or enable transfers of funds to more than one payee 108 by more than one user 100 via a single social post message. Methods and systems in accordance with some embodiments can enable merchants to make offers of products to a user 100, or payee/s 108. For example, a lifestyle engine 210 (FIG. 2) as described later herein can monitor user 100 social media activity and use predictive analytics to present offers and recommend products. The bank system 104 has access to account balances for account holders, in addition to various types of personal information about account holders. For example, most banks or financial institutions have access to credit records for account holders and to transactional history for account holders, so that the bank or financial institution can flag problematic transactions. Accordingly, methods and systems in accordance with some embodiments can detect fraudulent transactions and provide notifications thereof.

FIG. 2 is a block diagram of a social payment system 110, according to an example embodiment. The social payment system 110 can include one or more components that define and apply contextual rules for determining contexts, on a real-time basis, in which the user 100 is more likely to, or has often in the past, made social payments. The social payment system 110 can also initiate payments based on contextual information, or other information gleaned from social media communications.

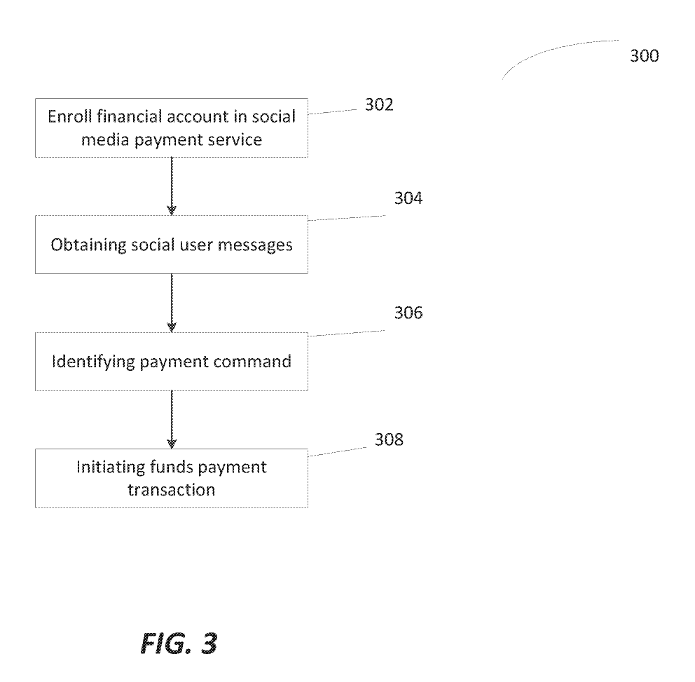

The social payment system 110 can include one or more processors that implement or execute various social payment components and algorithms. For example, the processor can implement a context parser component 202 to obtain the context of social message posts for use in determining whom should be paid, how much they should be paid, etc. The context parser component 202 can receive text strings, over the network port 204, from the bank system 104 (which the bank system 104 can receive from social media networks 106 through interaction with the user 100 (FIG. 1)) and the context parser component 202 can identify payment commands from those text strings through usage of a context database 206. Once payment commands are obtained, the context parser component 202 can provide the payment commands to a payment initiation component 208. The payment initiation component 208 will communicate with the bank system 104 to perform the actual transaction once it is initiated and approved as described below with respect to FIG. 3.

The context parser component 202 can also store the payment commands in the context database 206. In other words, the context parser component 202 can read from or write to the context database 206. The various contexts in which a payment is made can be learned, and/or can be stored in the context database 206. For example, a user 100 can indicate that #payJoe is a contextual cue for payments, and the social media network 106 will cause the string #payJoe to be stored in the context database 206. Text strings subsequently retrieved over the network port 204 can then be parsed for payment commands based on the contents of the context database 206.

Other types of context besides explicit context of actual payments can be stored in the context database 206. For example, the social payment system 110 can use access to the social media network 106 to detect certain financial or lifestyle characteristics. These characteristics can provide contextual cues for determining who a payee might be. For example, if the user 100 is at a school and there have been recent posts about a bake sale, this could be a contextual cue that a baked goods payment is about to be made. These contextual cues can be stored in the context database 206 and used for machine learning of typical payment scenarios.

The lifestyle engine 210 can aggregate transactions of a user 100 or payee/s 108, to determine any products or services that are relevant for offering to the user 100 or payee/s 108. The lifestyle engine 210 can detect behavior, demographics, product loyalty etc. for the user 100 or payee/s 108 or for friends or followers of the user 100 or payee/s 108. The lifestyle engine 210 can post, or cause to be posted, messages on the customer system 102 or on the social media accounts of the user 100 or payee/s 108. In some embodiments, the user 100 can reference these offers when initiating payments, or payee/s 108 can reference these offers when requesting payments.

The lifestyle engine 210 can also write lifestyle events to the context database 206 for use in learning events in which payments are often made by the user 100. These characteristics can also be stored for later processing or used immediately to determine if a financial transaction should proceed. For example, the social payment system 110 can detect that the user 100 is a church member or active with the parent-teacher organization to help make creditworthiness assessments. The characteristics can be further propagated up to the bank system 104 for creditworthiness, fraud detection, or other assessments as are typically performed by financial institutions. The characteristics can further include time-based information or habit information. These characteristics can be used for machine learning algorithms to generate predictive models that can predict when a payment is likely to be made. For example, if a user 100 is typically at a golf course every Thursday afternoon, it can be predicted that the user 100 will treat a golf partner to a round of golf, and such predictions and associated strings (e.g., golf partner name, golf course name) can be stored as context cues in the context database 206. Subsequently-retrieved text strings, retrieved on Thursday afternoons in the illustrative example, can be predicted to trigger a payment.

A social payment database 212 can store social payment enrollment information. For example, an entry of the social payment database 212 can include a financial account number, and a list of one or more social media networks 106 from which the user 100 is authorizing payments. In some embodiments, the user 100 can be requested to provide contextual cues during the enrollment, e.g., to specify certain text strings that will be stored in the context database 206 for identifying payment commands in later operations.

The social payment system 110 can include other components (not shown in FIG. 2) to access account-related data to identify other transactions that can be linked to the same account or associated user (e.g., by associating similar names, addresses and other identifying data) or for accessing and analyzing account history for accounts, on either the payee or payor side of the transaction.

FIG. 3 illustrates a method 300 of performing a social payment according to an example embodiment. A bank system 104, including components of the social payment system 110 or other bank system 104 components or databases, can perform one or more of the operations of method 300. The social payment system 110 can monitor social media messages in real-time, whether pushed from the social media network 106 or pulled from the social media network 106, to analyze contextual cues or other information and to initiate or perform a transaction.

The example method 300 begins at operation 302, with enrolling at least one financial account into a social media payment service. The enrollment can be stored in the social payment database 212. The enrollment can be completed when the user 100 fills out an input form (e.g., an HTML input form) where the user enters social media login information as described above. In order to enhance security, in some embodiments, the social payment system 110 will not store login information. In some embodiments, the social payment system 110 will store encrypted versions of some strings. The user 100 can select one or more social media networks for which to enroll social media payment services. For example, the social media payment service may be enabled for Facebook, but not for Twitter.

The example method 300 continues with operation 304 with obtaining social user messages generated by the user 100 on a social media system selected by the user 100 during the enrolling.

The example method 300 continues with operation 306, with identifying a payment command within the social user messages based on contextual cues or on other strings, hashtags, etc. associated with social user messages. The contextual cues can include string-based entries in the context database 206 (FIG. 2). Accordingly, identifying the payment command can include parsing a social user message of the social user messages into one or more strings, extracting a payment command string within the one or more strings by comparing the one or more strings with contextual cues of the context database 206, through query mechanisms (e.g., structured query language (SQL) queries).

As described earlier herein, the context database 206 can be populated through numerous sources, such as direct user input of preferred contextual cues (during the enrollment process or at any point thereafter), during analysis of user activity, etc. For example, the contextual cues can be derived from at least one of user location information and payee location information. Therefore, parsing the social user message includes detecting at least one of user location information and payee location information associated with the social user message such that at least one of the one or more strings within the social user message includes at least one of user location information and payee location information.

In embodiments, the user 100 can provide the social media post to the payee/s 108 (e.g., the user 100 can post #thanksforthegolfround on the payee's Facebook wall). In some embodiments, the social payment system 110 can be authorized by the user 100 to read every social message/post entered by the user from other client programs and in addition received messages that are sent to the user 100 by other users. Accordingly, the social payment system 110 can parse all social media posts by the user 100 or to the user 100 to determine which, if any, can include payment details. The social media post can be pushed to the social payment system 110, or the social payment system 110 can pull the social media post from the social media network 106.

The example method 300 continues with operation 308, in which the social payment system 110 initiates a funds payment transaction. The social payment system 110 can alert the user 100 that a payment is about to made, or request confirmation, using a pop-up message, with or without an audible alarm, for example. If the social payment system 110 determines that the probability of fraud is high due to, e.g., rules set up at the bank system 104, operation 308 can include not allowing the transaction to proceed without e-mail or phone confirmation of the transaction.

Payments can be recurring or one-time. For example, the user 100 can set up a recurring utility payment by posting on the utility company's Facebook wall, by way of nonlimiting example. In some embodiments, the social payment system 110 can determine that the payee 108 has no account into which funds can be transferred, and the social payment system 110 can notify the payee 108 that a target account should be set up to receive payments. If all requirements are met for processing the transaction, the social payment system 110 can generate a transaction trigger associated with the social media post or message that triggered the payment, and store a transaction trigger ID, together with the actual text for the post, in the context database 206 for analytics or machine learning purposes. The payment initiation component 208 can communicate with other components of the bank system 104 to handle the actual payment from the user 100 to the payee/s 108.

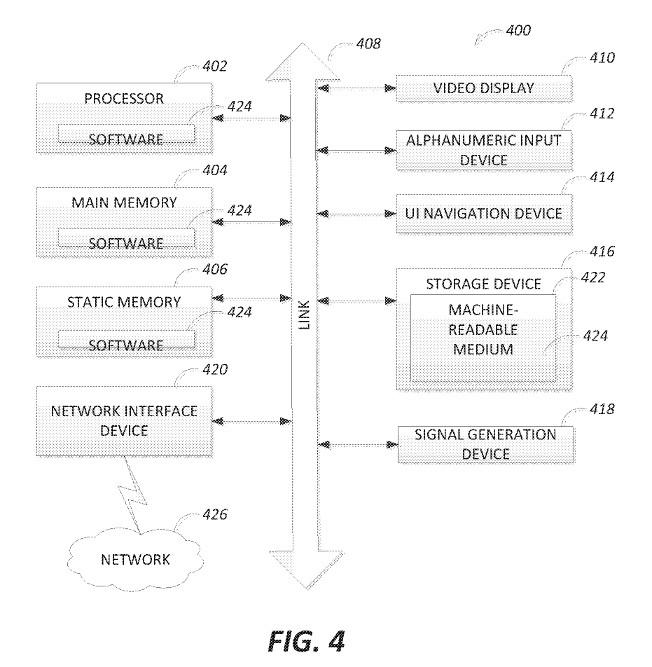

FIG. 4 is a block diagram illustrating components of the customer system 102 or the bank system 104 according to some example embodiments, able to read instructions from a machine-readable medium (e.g., a machine-readable storage medium) and perform any one or more of the methodologies discussed herein. Specifically, FIG. 4 shows a diagrammatic representation of the customer system 102 or the bank system 104 in the example form of a computer system and within which instructions 424 (e.g., software) for causing the customer system 102 or the bank system 104 to perform any one or more of the methodologies discussed herein can be executed.

In alternative embodiments, the customer system 102 or the bank system 104 operates as a standalone device or can be connected (e.g., networked) to other machines. In a networked deployment, the customer system 102 or the bank system 104 can operate in the capacity of a server machine or a client machine in a server-client network environment, or as a peer machine in a peer-to-peer (or distributed) network environment. The customer system 102 or the bank system 104 can be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 424, sequentially or otherwise, that specify actions to be taken by that machine. Further, while only a single machine is illustrated, the term “machine” shall also be taken to include a collection of machines that individually or jointly execute the instructions 424 to perform any one or more of the methodologies discussed herein. For example, when acting as a social payment system 110, the instructions 424 can cause social payment system 110 to perform operations including enrolling at least one financial account of a user into a social media payment service; obtaining social user messages generated by the user on a social media system selected by the user during the enrolling; identifying a payment command within the social user messages based on contextual cues associated with the user; and initiating a funds payment transaction from the at least one financial account based on the payment command.

The customer system 102 or bank system 104 includes at least one processor 402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 404, and a static memory 406, which are configured to communicate with each other via a bus 408. Among other usages, the main memory 404 or static memory 406 can store database tables for querying operations related to bank accounts, governmental blacklists or other governmental databases, currency data, etc., as described earlier herein. The customer system 102 or bank system 104 can further include a graphics display 410 (e.g., a plasma display panel (PDP), a light emitting diode (LED) display, a liquid crystal display (LCD), a projector, or a cathode ray tube (CRT)). The graphics display 410 can display any data associated with bank accounts, such as account balances, advertisements for additional services, geographically specific data, etc. The customer system 102 or bank system 104 can also include an alphanumeric input device 412 (e.g., a keyboard), a cursor control device 414 (e.g., a mouse, a touchpad, a trackball, a joystick, a motion sensor, or other pointing instrument), a storage unit 416, a signal generation device 418 (e.g., a speaker), and a network interface device 420.

The storage unit 416 includes a machine-readable medium 422 on which is stored the instructions 424 (e.g., software) embodying any one or more of the methodologies or functions described herein. The instructions 424 can also reside, completely or at least partially, within the main memory 404, within the processor 402 (e.g., within the processor's cache memory), or both, during execution thereof by the customer system 102 or the bank system 104. Accordingly, the main memory 404 and the processor 402 can be considered as machine-readable media. The instructions 424 can be transmitted or received over a network 426 via the network interface device 420.

As used herein, the term “memory” refers to a machine-readable medium able to store data temporarily or permanently and can be taken to include, but not be limited to, random-access memory (RAM), read-only memory (ROM), buffer memory, flash memory, and cache memory. While the machine-readable medium 422 is shown in an example embodiment to be a single medium, the term “machine-readable medium” should be taken to include a single medium or multiple media (e.g., a centralized or distributed database, or associated caches and servers) able to store instructions 424. The term “machine-readable medium” shall also be taken to include any medium, or combination of multiple media, that is capable of storing instructions (e.g., software) for execution by a machine (e.g., the customer system 102 or the bank system 104 (FIG. 1)), such that the instructions, when executed by one or more processors of the machine (e.g., processor 402 or processors for the social payment system 110 (FIG. 1)), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Certain embodiments are described herein as including logic or a number of components, modules, or mechanisms. Modules can constitute either software modules (e.g., code embodied on a non-transitory machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some embodiments, a hardware module can be implemented mechanically, electronically, or any suitable combination thereof. For example, a hardware module can include dedicated circuitry or logic that is permanently configured to perform certain operations. For example, a hardware module can be a special-purpose processor, such as a field programmable gate array (FPGA) or an ASIC. A hardware module can also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software can accordingly configure a processor, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, a processor being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an application program interface (API)).

The performance of certain of the operations can be distributed among the one or more processors, not only residing within a single machine, but also deployed across a number of machines. In some example embodiments, the one or more processors or processor-implemented modules can be located in a single geographic location (e.g., within a home environment, an office environment, or a server farm). In other example embodiments, the one or more processors or processor-implemented modules can be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities can take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like can refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance.

1. A method, comprising:
enrolling, using a hardware processor, at least one financial account of a user and a social media system into a social media payment service;
obtaining social user messages generated by the user on the social media system;
identifying location information based on the social user messages;
generating at least one contextual cue based on user activity predictions, the user activity predictions being based on social information of a location identified with the location information;
identifying a payment command within the social user messages based on the at least one contextual cue; and
initiating a funds payment transaction from the at least one financial account based on the payment command.

2. The method of claim 1, wherein the contextual cues include string-based entries in a context database, and wherein identifying the payment command includes:
parsing a social user message of the social user messages into one or more strings;
extracting a payment command string within the one or more strings by comparing the one or more strings with contextual cues; and
determining at least one of a payee identifier and a payment amount using the pay command string.

3. The method of claim 2, further comprising:
receiving user input of preferred contextual cues; and
storing the preferred contextual cues in the context database.

4. The method of claim 3, wherein enrolling the at least one financial account of the user further includes:
requesting preferred contextual cues from the user.

5. (canceled)

6. The method of claim 2, further comprising:
storing the contextual cues in the context database.

7. The method of claim 2, further comprising:
determining that payment verification is required from at least one of the user and a payee of the funds payment transaction;
generating a payment verification request using the social pay command; and
providing the payment verification request.

8. The method of claim 2, further comprising:
analyzing the pay command to determine whether the funds payment transaction should be initiated; and
providing a notification to terminate the funds payment transaction upon determining that the social pay command is a fraudulent transaction attempt.

9. The method of claim 8, wherein analyzing the pay command comprises:
retrieving historical transaction data from a financial institution system; and
analyzing at least one of user location information and a requested payment amount for the funds payment transaction to detect fraudulent activity.

10. The method of claim 1, wherein the obtaining of social user messages is continually intercepted in real time while the user engages in social media messaging.

11. The method of claim 10, wherein the social user messages are pulled from the social media system by a bank system.

12. The method of claim 10, wherein the social user messages are pushed to a bank system by the social media system.

13. A system comprising:
a memory to store a context database and enrollment information for financial accounts, the enrollment information linking financial accounts to at least one social media system;
a network interface to communicate to the at least one social media system; and
a processor to
receive user input to enroll at least one financial account of a user and the at least one social media system into a social media payment service;
obtain social user messages from the network interface, generated by the user on the at least one social media system;
identify location information based on the social user messages;
generate at least one contextual cue based on user activity predictions, the user activity predictions being based on social information of a location identified with the location information;
identify a payment command within the social user messages based on the at least one contextual cue; and
initiate a funds payment transaction from the at least one financial account based on the payment command.

14. The system of claim 13, wherein the processor is further configured to:
parse a social user message of the social user messages into one or more strings;
extract a payment command string within the one or more strings by comparing the one or more strings with contextual cues; and
determine at least one of a payee identifier and a payment amount using the pay command string.

15. (canceled)

16. The system of claim 13, wherein the processor is further configured to:
continuously intercept social user messages in real time while the user engages in social media messaging.

17. A non-transitory machine-readable medium comprising instructions that, when executed by at least one processor, cause the at least one processor to perform operations, the operations comprising:
enrolling at least one financial account of a user and a social media system into a social media payment service;
obtaining social user messages generated by the user on a social media system selected by the user during the enrolling;
identifying at location information based on the social user messages;
generating at least one contextual cue based on user activity predictions, the user activity predictions being based on social information of a location identified with the location information;
identifying a payment command within the social user messages based on the at least one contextual cue; and
initiating a funds payment transaction from the at least one financial account based on the payment command.

18. The non-transitory machine-readable medium of claim 17, wherein the instructions cause the at least one processor to perform further operations comprising:
parsing a social user message of the social user messages into one or more strings;
extracting a payment command string within the one or more strings by querying a context database based on the one or more strings, wherein the context database includes context cues; and
determining at least one of a payee identifier and a payment amount using the pay command string.

19. The non-transitory machine-readable medium of claim 18, wherein the instructions cause the at least one processor to perform further operations comprising:
receiving user input of preferred contextual cues; and
storing the preferred contextual cues in the context database.

20. The non-transitory machine-readable medium of claim 19, wherein at least some contextual cues are retrieved from the user during enrollment of the at least one financial account.
